(19) United States
(12) Patent Application Publication
(10) Pub. No.: US 2023/0011406 A1
(43) Pub. Date: Jan. 12, 2023

(54) ANTI-LIGATURE WARDROBE

(71) Applicant: E.B. ENDRES, INC., Huntingdon, PA (US)

(72) Inventor: Richard J. ENDRES, JR., Huntingdon, PA (US)

(21) Appl. No.: 17/726,988

(22) Filed: Apr. 22, 2022

Related U.S. Application Data
(60) Provisional application No. 63/219,415, filed on Jul. 8, 2021.

(51) Int. Cl. A47B 61/00; A47B 55/00; E05B 69/00

(52) U.S. Cl. CPC A47B 61/00; A47B 55/00; E05B 69/00

(57) ABSTRACT

A wardrobe incorporating anti-ligature design to minimize possibilities of use for self-harm. Access to wardrobe interior is managed by a roll-up door which eliminates ligature attachment locations and may be locked in fully open, fully closed, or partially open positions to manage access to the wardrobe interior. One or more storage drawers are provided in the interior. Drawer access is permitted only when the door is fully or partially open. Access to the balance of the interior space is blocked by a partially opened door. The wardrobe is constructed of durable materials suitable for use in institutional settings. Tam per-resistant components and fasteners are utilized exclusively to prevent disassembly. Moisture resistant materials are preferred and may be vinyl coated or laminated to further improve impermeability to moisture, allow for more effective surface cleaning, and to improve resistance to marking by pens and the like.

### CROSS-REFERENCE TO RELATED APPLICATIONS

This application claims the benefit of priority of U.S. Provisional Application 63/219,415, filed Jul. 8, 2021.

### BACKGROUND OF THE INVENTION

The present invention relates to furniture, and, more particularly, anti-ligature features and assemblies incorporated into wardrobes to thwart attempts by individuals to harm themselves by attaching ligatures to the wardrobe or configuring the wardrobe to create a ligature point.

Hanging is a common method of suicide worldwide and is ranked as a leading method used by persons attempting suicide in the United States. With this method of suicide, a person uses some form of ligature, e.g. shoe laces, electrical cords, belts, ropes, clothing, cables, etc., that is fixed both around the throat and at a ligature point. Ligature points are areas where a suicidal person can place a ligature to provide means for hanging. Individuals detained in institutional facilities are especially susceptible to suicidal attempts. For that reason, institutional facilities must take extra precautions to eliminate potential means for individual self-harm.

In special care environments and institutional settings, there is a need for furniture and room designs designed to minimize configurations or opportunities for individuals in these environments to harm themselves. Furniture meeting these needs should be constructed using durable and damage resistant materials are chosen for construction. Tamper resistant hardware should be used to prevent disassembly or partial disassembly into components that could be used to inflict self-harm or to harm others. Provisions allowing furniture to be securely attached to walls or floors to preclude tipping or movement of the furniture are essential.

Anti-ligature furniture is defined as furniture which eliminates possible points for attaching rope, wires, or cords to the furniture, which reduces the potential for attachment of a ligature which could be used for self-harm. Anti-ligature furniture for use in institutional or detention settings should contain a pick-proof perimeter sealant and form an impenetrable barrier, making concealment of contraband impossible and lessening the likelihood of furniture disassembly into potential weapons. Anti-ligature furniture must be extremely durable, breakage resistant, and capable of withstanding the wear and tear of demanding environments and continuous use in any institutional environment.

It would be advantageous to provide a ready for installation wardrobe or similar storage closet incorporating anti-ligature design considerations to minimize opportunities for a person to harm themselves using furniture once installed into a special care or institutional facility.

### SUMMARY OF THE INVENTION

Accordingly, the present invention, in any of the embodiments described herein, may provide one or more of the following advantages:

It is an object of the present invention to provide a wardrobe incorporating anti-ligature design to minimize possibilities of use for self-harm. The wardrobe may be securely attached to a wall in a room to prevent movement or tipping. Hardware used in construction and installation is tamper-resistant to prevent complete or partial disassembly of the wardrobe into component parts that might be used for self-harm or to harm others.

It is a further object of the present invention to provide an anti-ligature wardrobe wherein access to the interior of the wardrobe is secured by a roll-up door which eliminates ligature attachment locations afforded by conventional hinged doors. The roll-up door may further be locked into fully open, fully closed, or partially open positions to manage access to the wardrobe interior.

It is a further object of the present invention to provide an anti-ligature wardrobe including one or more pull-out storage drawers in the wardrobe interior. Access to the drawers may be managed by positioning a roll-up door to limit the drawers that may be accessed. The drawers may further be provided with locking means to allow for secure storage or to prevent drawer access except under managed supervision. Drawers are provided with anti-disconnect slides to prevent unauthorized removal from the wardrobe.

It is another object of the present invention to provide an anti-ligature wardrobe that is constructed of durable materials suitable for use in institutional settings. Moisture resistant materials are preferred and may be vinyl coated or laminated to further improve impermeability to moisture and make the surfaces more resistant to marking by pens and the like.

It is a still further object of the present invention to provide an anti-ligature wardrobe for use in institutional settings that is inexpensive to manufacture, durable, and simple and effective to use.

These and other objects are achieved in accordance with the present invention by providing a wardrobe incorporating anti-ligature design to minimize possibilities of use for self-harm. The wardrobe may be securely attached to a wall in a room to prevent movement or tipping. Hardware used in construction and installation is tamper-resistant to prevent complete or partial disassembly of the wardrobe into component parts that might be used for self-harm or to harm others. Access to the interior of the wardrobe is secured by a roll-up door which eliminates ligature attachment locations created when conventional hinged doors are used. One or more pull-out storage drawers are provided in the wardrobe interior. Access to wardrobe interior is managed by a roll-up door that may be locked into fully open, fully closed, or partially open positions to manage access to the wardrobe interior and drawers. Drawers are provided with anti-disconnect slides to prevent unauthorized removal from the wardrobe. The wardrobe is constructed of durable materials suitable for use in institutional settings. Moisture resistant materials are preferred and may be vinyl coated or laminated to further improve impermeability to moisture, allow for more effective surface cleaning, and to improve resistance to marking by pens and the like.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 perspective view of an exemplar anti-ligature wardrobe cabinet embodying aspects of the present invention;

FIG. 2 perspective view of the anti-ligature wardrobe cabinet of FIG. 1 wherein the door is opened enabling access to an interior space;

FIG. 3 is a left side elevation view of the furniture wardrobe of FIG. 1;

FIG. 4 is a right side elevation view of the furniture item of FIG. 1;

FIG. 5 is a front elevation view of the furniture item of FIG. 1 shown with a door in a fully closed position;

FIG. 6 is a front elevation view of the furniture item of FIG. 1 shown with a door in a partially opened position;

FIG. 7 is a front elevation view of the furniture item of FIG. 1 shown with a door in a fully opened position; and

FIG. 8 is a section view of FIG. 1 taken along cut line 8-8 in FIG. 7.

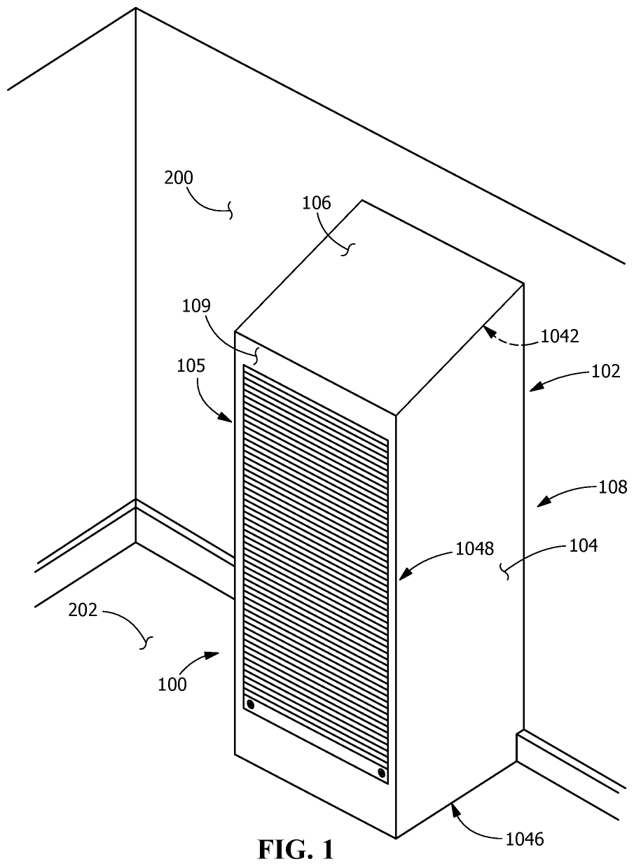

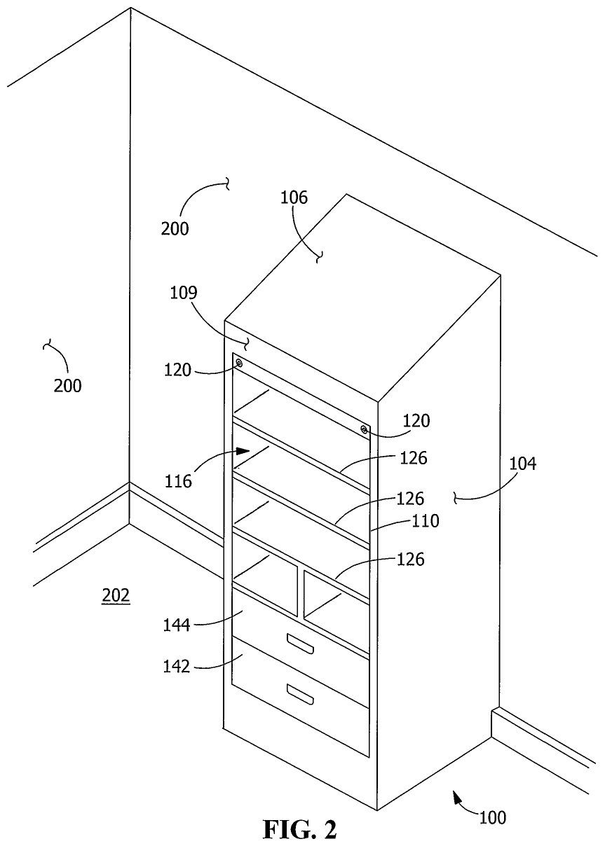

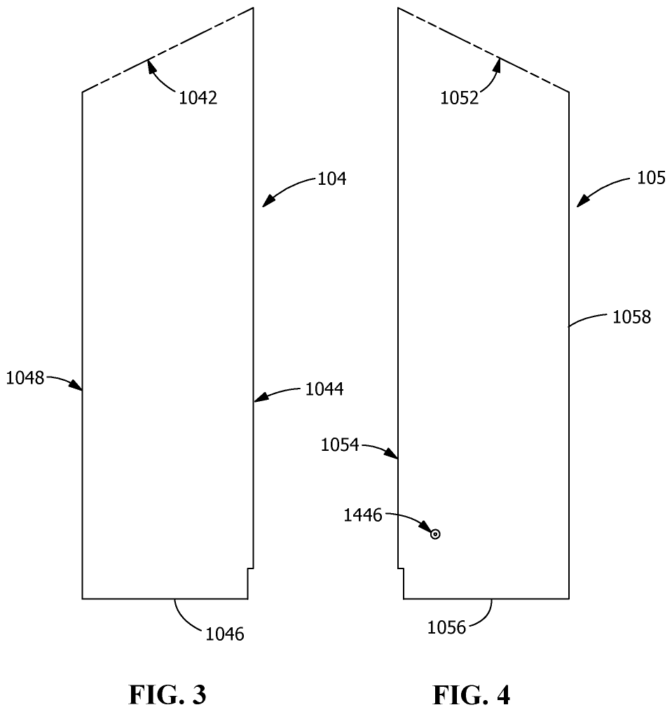

### DESCRIPTION OF THE PREFERRED EMBODIMENT(S)

Many of the fastening, connection, processes and other means and components utilized in this invention are widely known and used in the field of the invention described, and their exact nature or type is not necessary for an understanding and use of the invention by a person skilled in the art, and they will not therefore be discussed in significant detail. Furthermore, the various components shown or described herein for any specific application of this invention can be varied or altered as anticipated by this invention and the practice of a specific application of any element may already be widely known or used in the art by persons skilled in the art and each will likewise not therefore be discussed in significant detail. When referring to the figures, like parts are numbered the same in all figures.

Referring to the figures, an anti-ligature wardrobe 100 suitable for institutional environments and useful for storage of clothing and other personal articles is presented. The wardrobe comprises an upstanding, generally rectangular cabinet 102 enclosing an interior space and having an opening on a front face that permits access to the interior space from outside of the cabinet. The cabinet is formed by generally spaced-apart opposing side wall panels 104, 105, a top panel 106 spanning between the side wall panels adjacent to respective uppermost ends 1042, 1052 thereof, a back panel 108 spanning between the side wall panels adjacent respective back ends 1044, 1054 thereof, and a floor panel 112 spanning between the side wall panels adjacent to respective lowermost ends 1046, 1056 thereof, and a front panel 109 spanning between the side panels adjacent respective forward ends 1048, 1058 thereof and opposite to the back panel, the front panel having an opening 110 allowing access to the interior space from the exterior of the cabinet 102.

The cabinet panels are joined using tamper-proof joining methods to prevent disassembly by an institutional occupant which could produce a ligature attachment location or allow removal of portions which could be used as a weapon or to inflict self-harm. Joining methods include blind joints in which no fastening hardware is necessary to maintain the connection, adhesives, and tamper-proof fastening hardware, such as tamper-proof screws. Assembly joints are sealed to create an impenetrable barrier at the panel connection joints and eliminate potential openings where contraband could be concealed in the cabinet joints.

The cabinet 102 is constructed from durable materials selected to withstand attempts to damage or disassemble the cabinet. Material should be water/moisture resistant and feature a smooth exterior surface for easy cleaning. Solid, composite, or laminate materials are contemplated. An exemplar material is medium density fiberboard (MDF) laminated with natural wood, vinyl, or other synthetic material. Synthetic laminates provide easy to clean surfaces that resist markings and easily allow color selection to match décor of the installation location.

The wardrobe cabinet 102 includes provisions for securing the cabinet to an adjacent wall to prevent unintentional movement, especially tipping. One exemplar provision includes one or more mounting rails 130 provided on an exterior surface of the back panel 108 placing them in adjacent contact with a wall 200. Tamper-proof anchoring screws may then be driven through the back panel and the mounting rail into the wall to engage structural members, such as a wall stud, within the wall structure. Anchorage to a floor 202 may also be utilized, though is recognized as generally being more difficult to install than a wall connection and may require more extensive repair should the cabinet need to be relocated.

The back ends 1044, 1054 of side panels 104, 105 may be extended beyond the exterior surface of the back panel 108 so that back ends 1044, 1054 are in contact with the surface of the wall next to which the cabinet is positioned. The extended portions of the side panels hide the mounting rails 130 from view and also preclude access to the space between the wall surface and the exterior surface of the back panel 108 where contraband may be concealed.

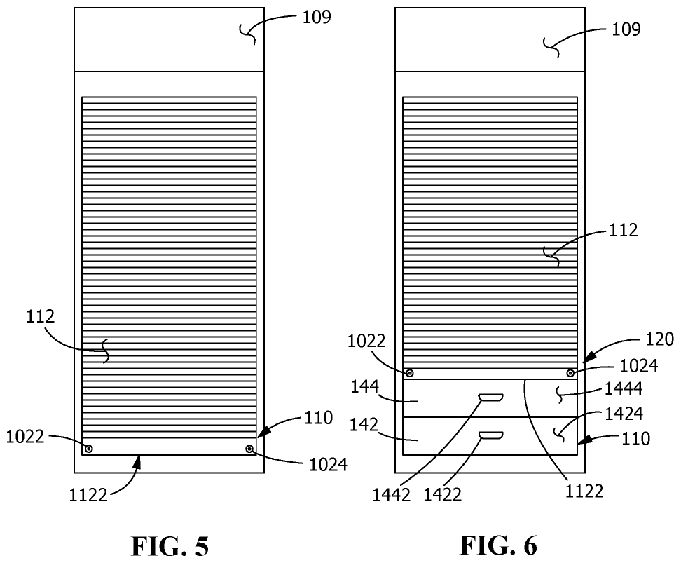

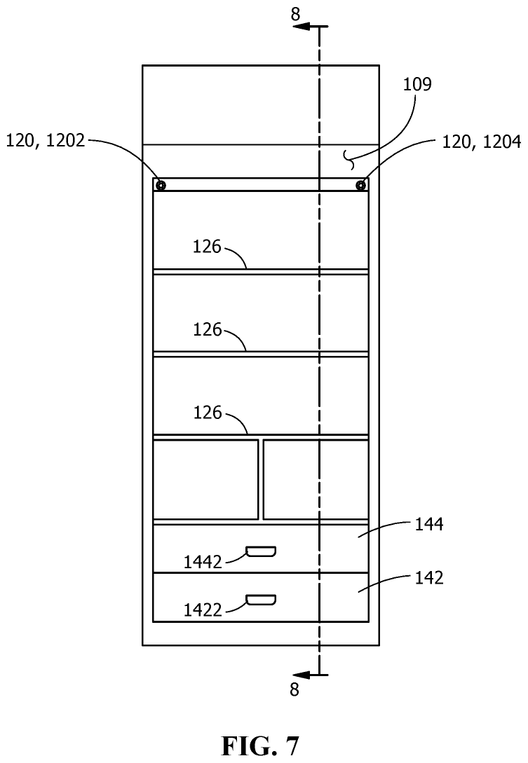

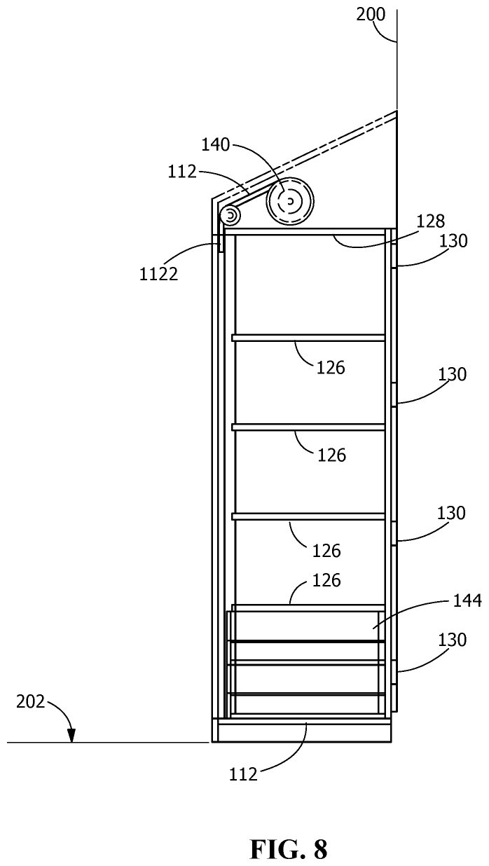

A moveable door 112 is provided to allow selective access to the cabinet interior space 116 through the opening 110. The door may be moved between opposing a fully open position (FIG. 7), a fully closed position (FIG. 5) and an intermediate position (FIG. 6) which allows limited access to a portion of the interior space from outside the cabinet.

The moveable door 112 is preferably a roll-up design to minimize spatial needs for situating the wardrobe by eliminating require swing clearance and positioning a retraction mechanism 140 and an opened door within the interior space. A roll-up door design also eliminates potential ligature attachment points created when opening a conventional swing-out door. The door has a bounding end 1122 which, as the door is repositioned, delineates the opening into areas that permit and prevent access to the interior space from the cabinet exterior. In the exemplar embodiment, door 112 opens from bottom to top.

A service panel 128 disposed in the upper extent of the interior space prevent access to the portion of the interior space where the roll-up door retraction mechanism 140 is disposed. The service panel 128 or a portion of the back panel or top panel may be configured suitable locking or similar capability to enable selective removal by authorized individuals to permit service of the door retraction mechanism and prevent access to the space by non-authorized persons.

The roll-up door is preferably fabricated from durable material to withstand attempts to breach the cabinet interior space. In the exemplar embodiment the roll-up door is fabricated from polyvinyl chloride (PVC) with an aluminum finish manufactured by Circa, model 20-5375.

The roll-up door includes a locking mechanism 120 that enables the door to be secured in at least the fully closed position (FIG. 5), a partially open position (FIG. 6), and a fully open position (FIG. 7). The locking mechanism 120 may include symmetrically located door lock devices 1202, 1204 disposed adjacent to the bounding end 1122 of door 112. Each door locking mechanism 120 preferably includes a keyed lock cylinder to improve security and to enable control and management of door positioning by administrators. In the exemplar embodiment, the door lock devices are Hafele Door Locks, Model 232.25.680 locks with locking cores.

The interior space of the cabinet may be provided with one or more slide-out drawers 142, 144 in the lower portion of the interior space. The slide-out drawers are moveable between generally opposing extended and retracted positions. The drawers are fully disposed within a portion interior space when retracted. When moved toward the extended position, a portion of the drawer projects through the opening such that a portion of the drawer is disposed outside of the cabinet.

The drawers are durable in construction and designed to support the weight of a person, even when extended. Drawer slide hardware precludes removal of the drawers without specialty tools to prevent drawer removal by institutional occupants. In the exemplar embodiment, the drawer slides are Accuride C9310E Heavy Duty non-disconnect full extension slides rated for 600 pounds. The exemplar drawers are formed from PVC and may be assembled using stainless steel temper proof fasteners.

The drawers include anti-ligature style pulls 1422, 1442, preferably in the form of indentations in the drawer front faces that may be engaged by a person's fingers to pull the drawers outwardly. The pulls 1422, 1442 may also be anti-ligature style pulls that are attached to the drawer faces 1424, 1444.

One or more shelves 126 may be provided in the interior space of the cabinet to increase usable storage within the cabinet. Each shelf 126 is fixedly connected to the cabinet in a manner that precludes removal, preferably using tamper-proof designs and/or fasteners. Access to the shelves is permitted when the door is moved to the fully opened position. Shelf access is blocked by the door when it is positioned in the intermediate position (FIG. 6) at which point the bounding end 1122 of the door is located adjacent to the uppermost drawer leaving a gap insufficient to permit access to the interior space.

A drawer locking device 1446 may be provided for one or more of the drawers to allow access control to the drawer. Access may be managed by the institution to limit access to the drawer(s) by the institutional occupant, or to provide a secure place for the institutional occupant to store valuables. One drawer is preferred to include a locking device. Access to both drawers may be prevented by positioning the door in the fully closed position. The exemplar drawer locking device is a Hafele push-button lock model 234.65.600 with a locking core.

The locking cores for the drawer locking device 1446 and the door lock devices 1202, 1204 may be keyed to allow operation by a single key to simplify administrative controls for use of the wardrobe in institutional settings.

Naturally, the invention is not limited to the foregoing embodiments, but it can also be modified in many ways without departing from the basic concepts. Changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

Having thus described the invention, what is claimed is:

1. An anti-ligature wardrobe assembly comprising:
a cabinet portion having an interior space defined by generally spaced-apart opposing side wall panels, a top panel spanning between and connected to the side wall panels adjacent an uppermost end thereof, a back panel spanning between and connected to the side wall panels adjacent a back end thereof, and a floor panel spanning between the side wall panels adjacent to a lowermost end thereof, and a front panel spanning between the side panels adjacent a forward end thereof and opposite to the back panel, the front panel having an opening allowing access to the interior space from the exterior of the cabinet portion, connections between the panels being tamper-resistant;
a door configured to selectively cover the front panel opening, the door moveable between an open position wherein the interior space is accessible from outside of the cabinet portion, and a closed position wherein the interior space is inaccessible from outside of the cabinet portion, the door being disposed within the interior space when moved toward the open position;
a mounting connector configured to enable immovable attachment of the cabinet portion to a fixed structure in a room thereby preventing tipping or lateral movement of the cabinet; and
a door locking mechanism configured to retain the door in one of a plurality of stationary positions, including the open position, the closed position and an intermediate position between the opened and closed positions.

2. The anti-ligature wardrobe assembly of claim 1, further comprising at least one drawer slidingly connected to the cabinet portion and moveable between generally opposing extended and retracted positions, the at least one drawer being fully disposed within a drawer portion of the interior space and blocked from movement toward the extended position by the door in the closed position, the at least one drawer being moveable to partially project through the opening such that a portion of the at least one drawer is accessible from outside of the cabinet portion when the door is in the open position or the intermediate position, the door when positioned in the intermediate position preventing access to the portion of the interior space that is not the drawer portion of the interior space.

3. The anti-ligature wardrobe of claim 2, wherein the at least one drawer further comprises a drawer locking mechanism configured to retain the drawer in the retracted position, the drawer locking mechanism being accessible for operation from the exterior of the cabinet portion.

4. The anti-ligature wardrobe of claim 1, wherein the door is a roll-up door configured to open by upward movement of a bounding end.

5. The anti-ligature wardrobe of claim 4, wherein the roll-up door includes a retraction mechanism configured to contain the door as it is moved toward the open position, the retraction mechanism being disposed in the interior space.

6. The anti-ligature wardrobe of claim 1, wherein the door locking mechanism comprises at least one lock disposed on the door and configured to selectively engage the cabinet portion and prevent opening or closing movement of the door.

7. The anti-ligature wardrobe of claim 1, further comprising at least one shelf disposed in the interior space, the at least one shelf being accessible from the exterior of the cabinet portion when the door is in the open position, the at least one shelf being inaccessible when the door is in the intermediate or the closed position.

8. An anti-ligature wardrobe assembly comprising:
a cabinet portion having an interior space defined by generally spaced-apart opposing side wall panels, a top panel, a back panel, and a front panel spanning having an opening allowing access to the interior space from the exterior of the cabinet portion, connections between the panels being tam per-resistant to prevent disassembly;
a door configured to selectively cover the opening, the door moveable between an open position enabling access to the interior space from outside the exterior, and a closed position wherein the interior space is inaccessible from the exterior, the door being disposed within the interior space when moved toward the open position;
a door locking mechanism configured to retain the door in one of a plurality of stationary positions, including the open position, the closed position and an intermediate position between the opened and closed positions; and
a mounting connector configured to attach the cabinet portion to an immoveable structure thereby preventing tipping or lateral movement of the cabinet.

9. The anti-ligature wardrobe of claim 8, wherein the door is a roll-up door having a bounding end that divides the opening into an open area and a blocked when the door is in the intermediate position, the open area permitting access from the cabinet exterior to an open portion of the interior space and the blocked area preventing access from the cabinet exterior to a blocked portion of the interior space.

10. The anti-ligature wardrobe assembly of claim 9, further comprising at least one drawer slidingly connected to the cabinet portion and moveable between generally opposing extended and retracted positions, the drawer when retracted being fully disposed within a drawer portion of the interior space and blocked from movement toward the extended position by the door when in the closed position, the drawer being partially extendible through the open area allowing access thereto from outside of the cabinet portion, the bounding end when the door is in the intermediate position being disposed adjacent to the at least one drawer thereby preventing access to blocked portion of the interior space.

11. The anti-ligature wardrobe of claim 10, further comprising at least one shelf disposed in the interior space, the at least one shelf being accessible from the exterior of the cabinet portion when the door is in the open position, the at least one shelf being inaccessible when the door is in the intermediate or the closed position.

12. The anti-ligature wardrobe of claim 8, wherein the door locking mechanism comprises at least one lock disposed on the door and configured to selectively engage the cabinet portion and prevent opening or closing movement of the door.
